(19) United States
(12) Patent Application Publication
(10) Pub. No.: US 2015/0049998 A1
(43) Pub. Date: Feb. 19, 2015

(54) Compact Optical Waveguide Arrays and Optical Waveguide Spirals

(71) Applicant: FUTUREWEI TECHNOLOGIES, INC., Plano, TX (US)

(72) Inventor: Patrick Dumais, Ottawa (CA)

(73) Assignee: FUTUREWEI TECHNOLOGIES, INC., Plano, TX (US)

(21) Appl. No.: 14/070,108

(22) Filed: Nov. 1, 2013

Related U.S. Application Data
(60) Provisional application No. 61/865,499, filed on Aug. 13, 2013.

(51) Int. Cl. G02B 6/04

(52) U.S. Cl. CPC G02B 6/04
USPC 385/115

(57) ABSTRACT

Crosstalk can be reduced in optical waveguide bundles by varying the widths of individual waveguides. Using different width waveguides reduces the growth of crosstalk between the optical waveguides, thereby allowing the waveguides to be placed in closer proximity to increase waveguide density on the chip and/or reduce the routing space required for the waveguide bundle. Moreover, varying the width of a waveguide spiral may reduce crosstalk, which can increase power efficiency when implemented in coiled or folded waveguide thermal optical (TO) devices.

This application claims the benefit of U.S. Provisional Application No. 61/865,499 filed on Aug. 13, 2013, entitled “Compact Optical Waveguide Arrays and Optical Waveguide Spirals,” which is incorporated herein by reference as if reproduced in its entirety.

### TECHNICAL FIELD

The present invention relates to optical waveguides, and, in particular embodiments, to compact optical waveguide arrays and optical waveguide spirals.

### BACKGROUND

Optical waveguides are physical structures that guide electromagnetic waves in the optical spectrum, and are often bundled together in order to route multiple signals in-between components of an integrated circuit. Notably, optical waveguides typically generate crosstalk when placed in close proximity, which may limit the density of optical waveguides on a chip as well as constrain layout flexibility and/or connectivity space requirements on the chip. In other words, chips having large number of devices may need to devote a substantial area on the chip for optical waveguide routing. Further, optical delay lines may be restrained by the compactness of waveguide spirals, which may require a minimum waveguide spacing for crosstalk reduction. The efficiency of spiral thermo-optic devices in relation to heat exchangers is also limited by the compactness of optical waveguide spirals. As such, techniques for achieving more compact waveguide bundles without increasing crosstalk are desired.

### SUMMARY OF THE INVENTION

Technical advantages are generally achieved, by embodiments of this disclosure which describe compact optical waveguide arrays and optical waveguide spirals.

In accordance with an embodiment, an apparatus for housing optical waveguides is provided. In this example, the apparatus includes a substrate layer and a waveguide bundle. The waveguide bundle includes a plurality of waveguides extending across the substrate layer. The waveguides run parallel to one another and include waveguides having three or more different widths.

In accordance with another embodiment, another apparatus for housing optical waveguides is provided. In this example, the apparatus includes a substrate layer and a continuous waveguide structure extending over the substrate layer. A width of the continuous waveguide structure varies over a length of the continuous waveguide structure.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates a diagram of a waveguide bundle;

FIG. 2 illustrates a diagram of a spiral waveguide structure;

FIG. 3 illustrates a diagram of a waveguide spiral implemented on a thermo-optic device;

FIG. 4 illustrates a diagram of an waveguide bundle including an arrayed waveguide (AWG) structure;

FIG. 5 illustrates a diagram of an a conventional waveguide bundle;

FIG. 6 illustrates a diagram of a pair of parallel waveguides;

FIG. 7 illustrates a graph depicting crosstalk in parallel waveguides;

FIG. 8 illustrates another graph depicting crosstalk in parallel waveguides;

FIG. 9 illustrates a diagram of an embodiment waveguide bundle;

FIG. 10 illustrates a diagram of another embodiment waveguide bundle;

FIG. 11 illustrates a diagram of yet another embodiment waveguide bundle;

FIG. 12 illustrates a diagram of an embodiment waveguide spiral; and

FIG. 13 illustrates a diagram of an embodiment computing platform.

### DETAILED DESCRIPTION OF ILLUSTRATIVE EMBODIMENTS

The making and using of embodiments of this disclosure are discussed in detail below. It should be appreciated, however, that the present disclosure provides many applicable inventive concepts that can be embodied in a wide variety of specific contexts. The specific embodiments discussed are merely illustrative of specific ways to make and use the invention, and do not limit the scope of the claimed invention.

Conventional waveguide bundles may typically consist of waveguides having identical widths. Aspects of this disclosure reduce crosstalk in optical waveguide bundles by varying the widths of the individual waveguides. More specifically, using different width waveguides reduces the growth of crosstalk between the optical waveguides, thereby allowing the waveguides to be placed in closer proximity to increase waveguide density on the chip and/or reduce the routing space required for the waveguide bundle. Accordingly, embodiments of this disclosure achieve more flexible and/or compact waveguide routing, which can increase power efficiency when implemented in coiled or folded waveguide thermal optical (TO) devices.

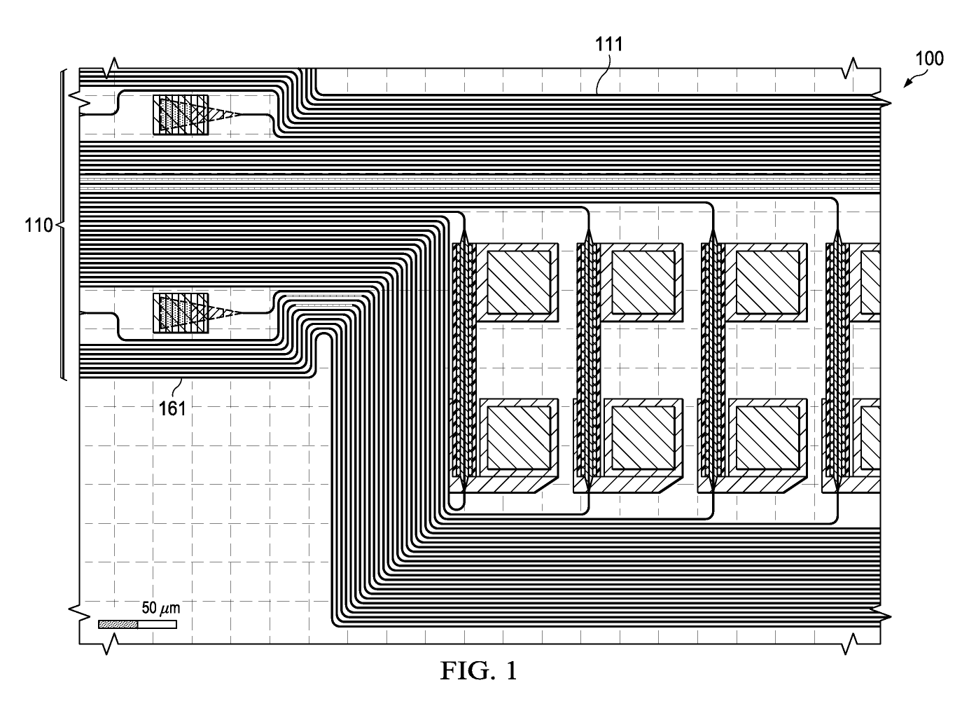

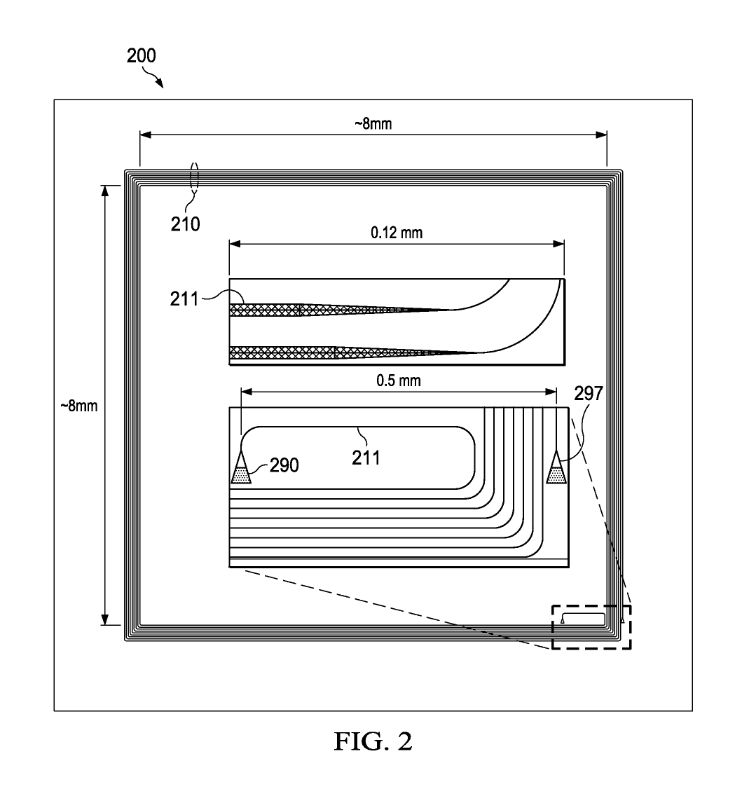

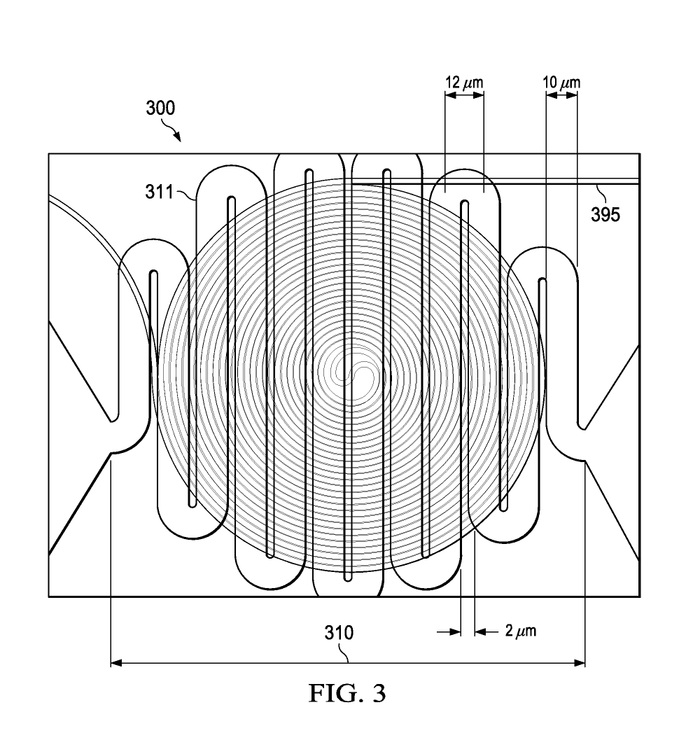

Waveguide bundles may include a plurality of waveguides. FIG. 1 illustrates a chip 100 comprising a waveguide bundle 110 that includes a plurality of waveguides 111-161. Waveguide bundles may also include a single waveguide arranged in a spiraled configuration. FIG. 2 illustrates a chip 200 comprising a spiral waveguide structure 210. The spiral waveguide structure 210 includes a single waveguide 211 that extends from a starting point 290 to an end-point 297. While the spiral waveguide structure 210 is depicted as having an outer dimension of eight millimeters (mm) by eight mm (8×8 mm), aspects of this disclosure can be applied to spiral waveguides having any dimension(s). Waveguides bundles may also be implemented in thermo-optic devices. FIG. 3 illustrates a waveguide spiral 395 implemented with a resistive heater 310 to form thermo-optic device 300. As shown, the resistive heater 310 is located on top of a cladding layer covering the waveguide spiral 395. The resistive heater may be positioned between 0.5 micron and 100 microns above the cladding layer. Aspects of this disclosure vary the width of waveguides, which may reduce crosstalk and/or increase power efficiency of the thermo-optic devices.

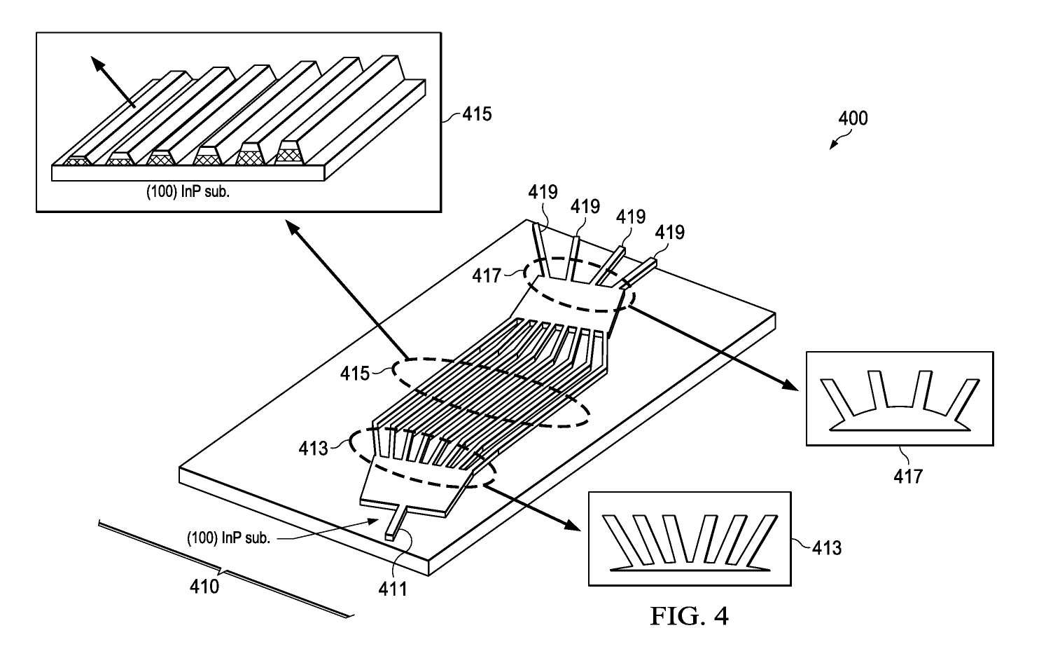

Waveguide bundles may also be implemented as arrayed waveguide (AWG) structures. FIG. 4 illustrates a chip 400 comprising a waveguide bundle 410 implemented as an arrayed waveguide (AWG) 415. As shown, the waveguide bundle 410 includes an input waveguide 411, an input coupler 413, an AWG 415, an output coupler 417, and a plurality of output waveguides 419. The input waveguide 411 couples to the input coupler 413, the AWG 415 extends between the input coupler 413 and the output coupler 417, and the output coupler 417 couples to the output waveguides 419. In some embodiments, the input coupler 413 and/or the output coupler 417 may comprise a star coupler configuration. In the same or other embodiments, the AWG 415 may be a selectively grown waveguide array.

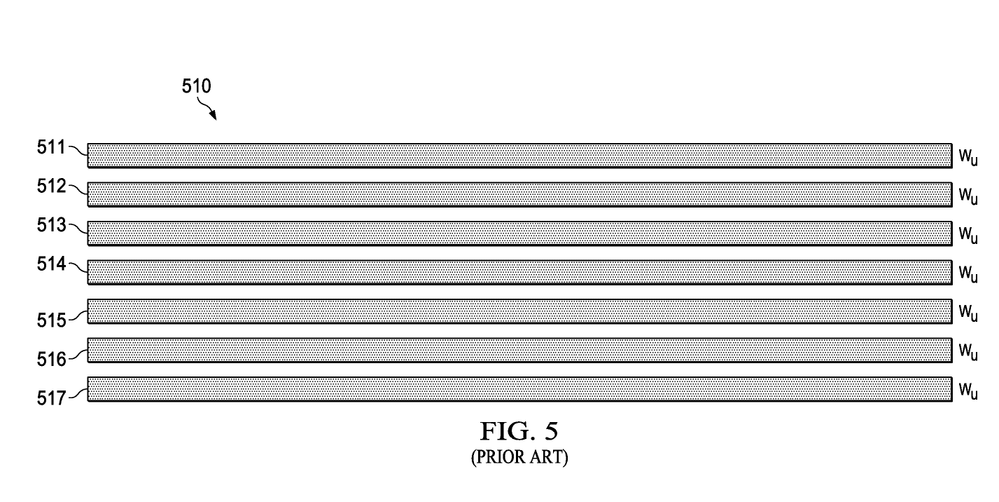

As mentioned previously, conventional waveguide bundles include waveguides having identical widths. FIG. 5 illustrates a conventional waveguide bundle 510 having a plurality of waveguides 511-517 with uniform widths (Wᵤ).

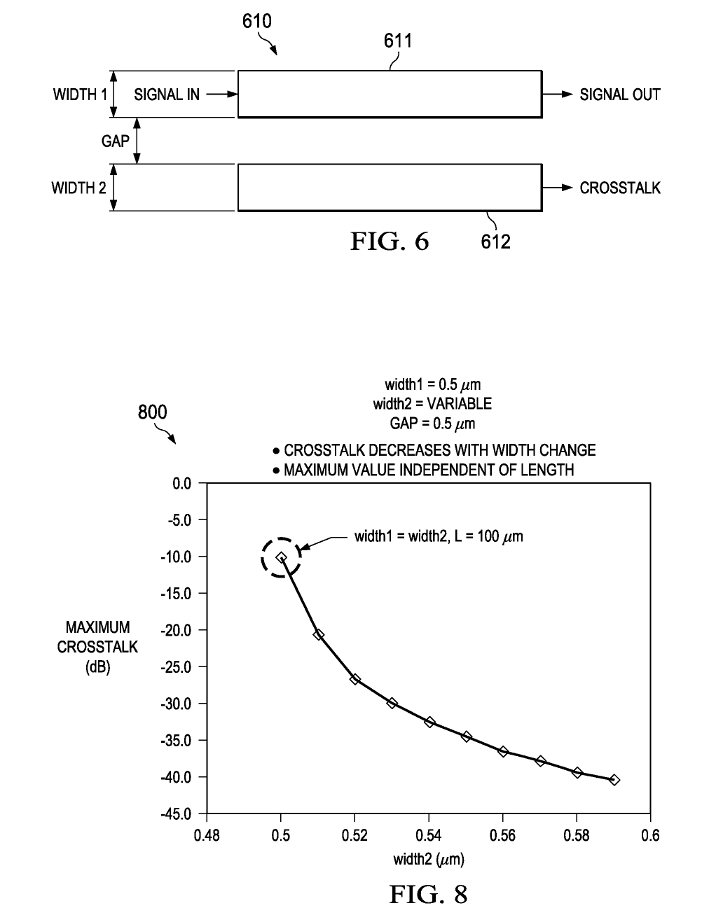

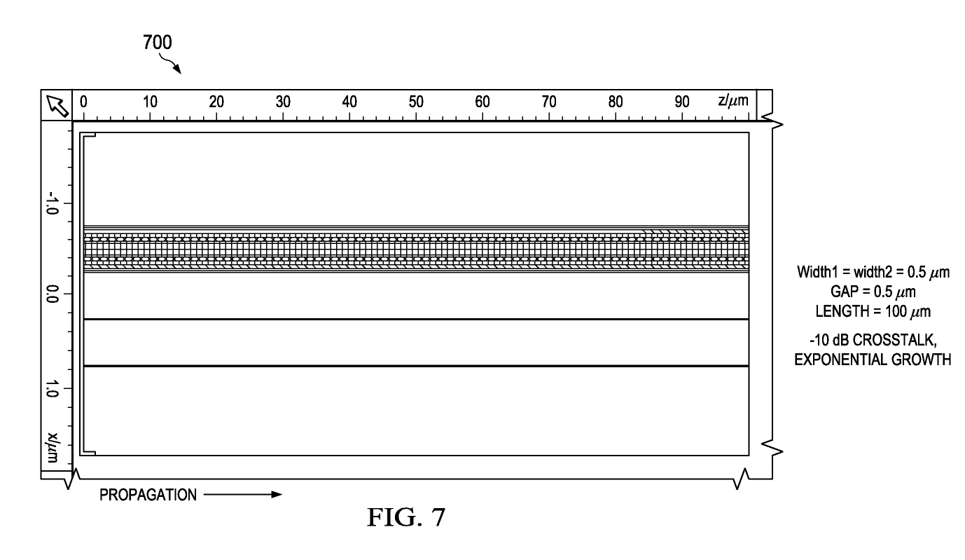

Aspects of this disclosure reduce crosstalk in optical waveguide bundles by varying the widths of individual waveguides in the bundle. The amount of crosstalk produced in parallel waveguides is significantly affected by the relative widths of the waveguides. FIG. 6 illustrates a parallel waveguide structure 610 comprising a pair of waveguides 611, 612 having a first width (width-1) and a second width (width-2), respectively. As shown, a signal fed into the waveguide 611 produces crosstalk in the waveguide 612. The amount of crosstalk produced in the waveguide 612 depends on various factors, including an inter-waveguide gap, a relative difference between the widths of the waveguides 611, 612 (e.g., width-1:width-2), and a length of the waveguides 611, 612. FIG. 7 illustrates a graph 700 depicting crosstalk produced in the waveguide 612 as a signal propagates through the waveguide 611 when the width-1 and width-2 are uniform. FIG. 8 illustrates a graph 800 depicting crosstalk produced in the waveguide 612 as the width-2 of the waveguide 612 is varied (the width-1 remains constant). In this example, width-1 is constant at 0.5 micrometer (μm), width-2 is varied from 0.5 μm to 0.6 μm, the inter-waveguide gap is constant at 0.5 μm, and the length of the waveguides 611, 612 is constant at 100 μm. As shown, there is approximately −10 decibels of crosstalk when width-2 is set equal to width-1. However, the amount of crosstalk is reduced significantly as the width-2 is increased from 0.5 μm to 0.6 μm. These calculations are primarily related to silicon-on-insulator waveguides, which have a height of approximately 220 nanometers (nm). However, the principles modeled by these calculations (e.g., that less crosstalk is produced as a relative difference between waveguide widths is increased) are applicable to other material systems as well, such as silica-on-silicon, silicon nitride, III-IV semiconductors, and others. The maximum value of crosstalk reduction may be independent of length.

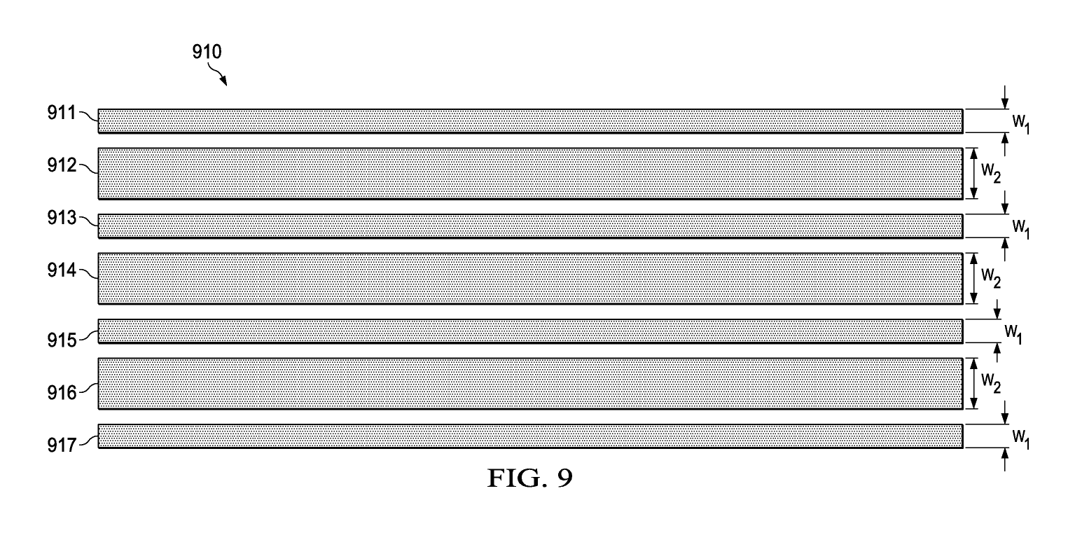

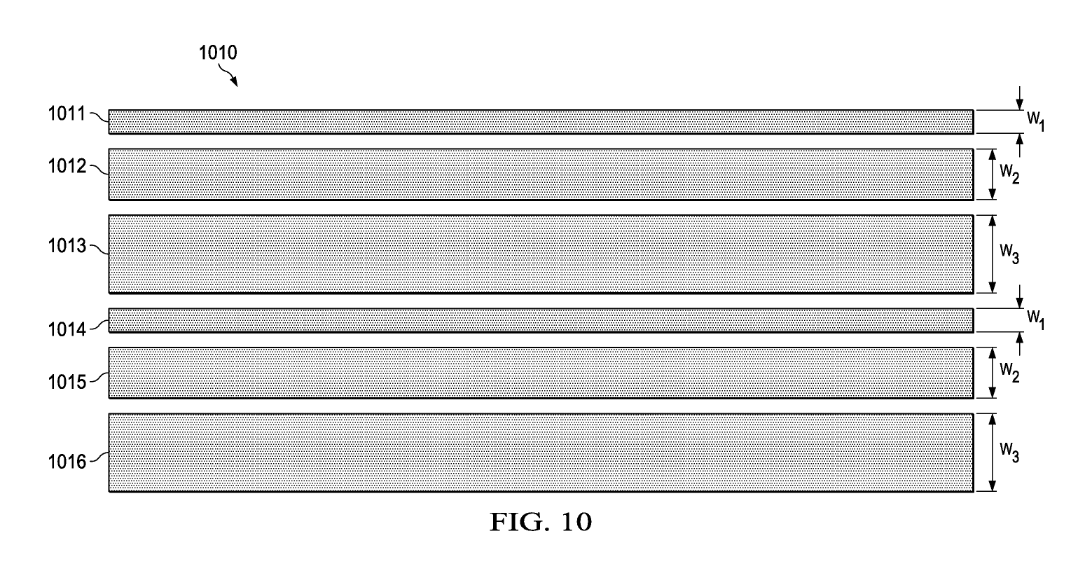

In some embodiments, waveguide bundles may include waveguides having alternating widths. FIG. 9 illustrates an embodiment waveguide bundle 910 having waveguides 911-917 with alternating widths. As shown, the waveguides 911, 913, 915, and 917 have a first width (w₁), while the waveguides 912, 914, and 916 have a second width (w₂). In some embodiments, waveguide bundles may include waveguides having three or more different widths which vary in a repeating pattern. FIG. 10 illustrates an embodiment waveguide bundle 1010 having waveguides 1011-1016. As shown, the waveguides 1011 and 1014 have a first width (w₁), the waveguides 1012, 1015 have a second width (w₂), and the waveguides 1013 and 1016 have a third width (w₃). In other embodiments, waveguide bundles can have three or more waveguide widths which vary in a non-repeating pattern.

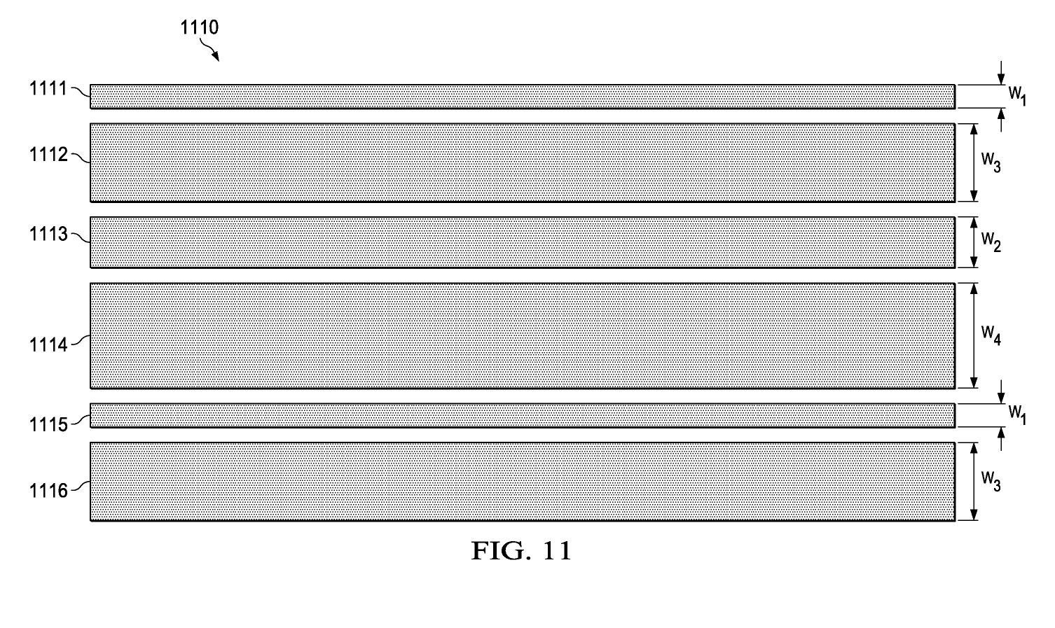

In some embodiments, waveguide bundles may include waveguides having random widths. FIG. 11 illustrates an embodiment waveguide bundle 1110 having waveguides 1111-1116 with random widths. As shown, the waveguides 1111 and 1115 have a first width (w₁), the waveguide 1113 has a second width (w₂), the waveguides 1112 and 1116 have a third width (w₃), and the waveguide 1114 has a fourth width (w₄). While the embodiment waveguide bundle 1100 shows four widths dispersed in a random pattern, other embodiments may include any number of widths dispersed in a random pattern. For example, each waveguide in an embodiment waveguide bundle may have a different width such that no two waveguides share the same width.

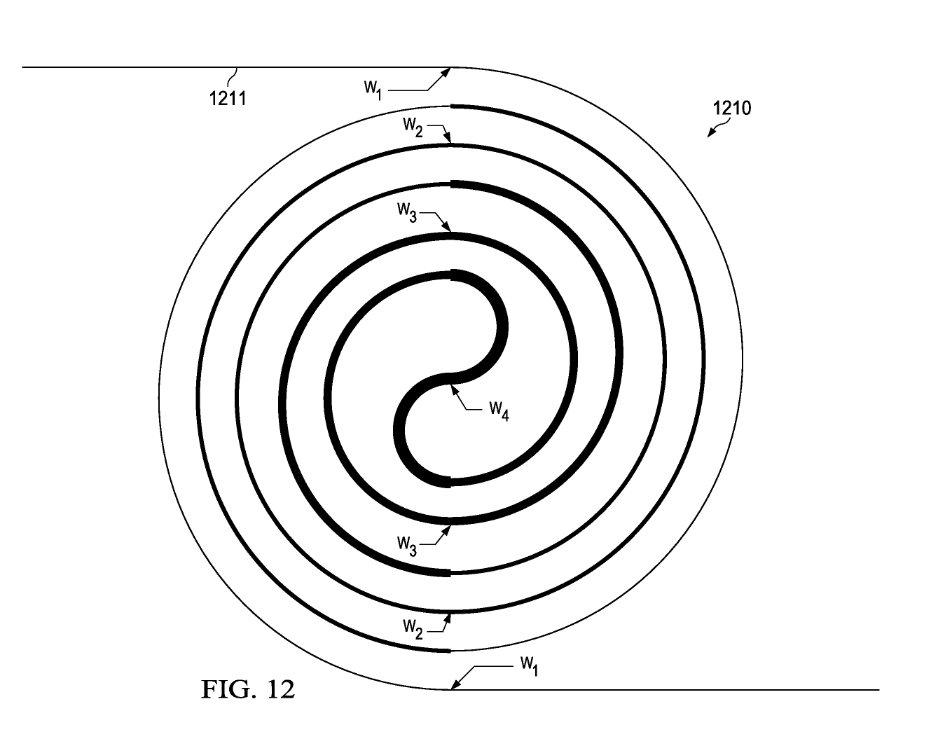

Aspects of this disclosure also provide spiral waveguide structures comprising a waveguide width that gradually (or incrementally) varies over the waveguide length. This may reduce back-reflection and/or Optical Return Loss (ORL) of the spiral waveguide. FIG. 12 illustrates a spiral waveguide 1210 comprising a waveguide 1211 with a width that varies over its length. As shown, the spiral waveguide 1210 has a different width (e.g., w₁, w₂, w₃, w₄, w₅, etc.) at different points. In some examples, the width of the spiral waveguide 1210 varies constantly (e.g., at a single absolute rate) over its length. In other examples, the width of the spiral waveguide 1210 varies at a dynamic rate that changes over the length of the spiral waveguide 1210. In yet other examples, the width of the spiral waveguide 1210 is varied in stages. For example, different links in the spiral waveguide 1210 may have different widths. As another example, different links in the spiral waveguide 1210 may have widths that vary at different rates.

Aspects of this disclosure vary the widths of waveguides in a waveguide bundle to reduce crosstalk and/or waveguide spacing. In some embodiments, a sequence of widths are used in a waveguide bundle to reduce crosstalk and/or inter-waveguide spacings. Aspects of this disclosure also utilize progressive/varying waveguide widths in a coiled or spiraled waveguide structure. This may cause neighboring “rings” to have different widths, which may reduce crosstalk in the coiled or spiraled waveguide structure and/or reduce the footprint of the coiled or spiraled waveguide structure. Additionally, utilizing progressive/varied waveguide widths in coiled/spiraled waveguide structures implemented on thermo-optic devices may increase the heat dissipation efficiency of those devices.

Crosstalk of neighboring waveguides can be reduced by selecting differing widths. Embodiment waveguide bundles may alternate between two widths, or have a repeating sequence of different widths. Embodiment waveguide bundles can include a nonrepeating sequence of different widths, or a sequence of random widths within a range. Embodiment waveguide spirals can include a progressive waveguide width along the spiral to reduce back-reflection and/or Optical Return Loss (ORL). Embodiments of this disclosure may increase the power efficiency of devices based on coiled-waveguides, such as coiled-waveguide thermo-optic phase shifters. Aspects of this disclosure may achieve more compact coiled waveguides.

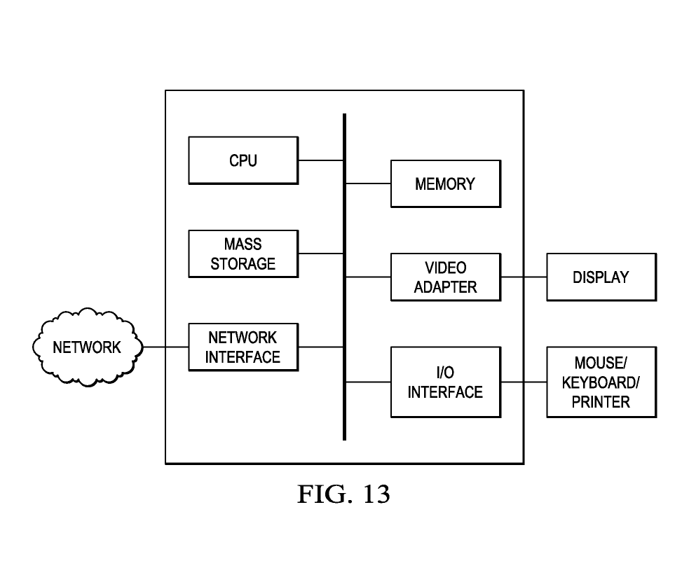

FIG. 13 is a block diagram of a processing system that may be used for implementing the devices and methods disclosed herein. Specific devices may utilize all of the components shown, or only a subset of the components, and levels of integration may vary from device to device. Furthermore, a device may contain multiple instances of a component, such as multiple processing units, processors, memories, transmitters, receivers, etc. The processing system may comprise a processing unit equipped with one or more input/output devices, such as a speaker, microphone, mouse, touchscreen, keypad, keyboard, printer, display, and the like. The processing unit may include a central processing unit (CPU), memory, a mass storage device, a video adapter, and an I/O interface connected to a bus.

The bus may be one or more of any type of several bus architectures including a memory bus or memory controller, a peripheral bus, video bus, or the like. The CPU may comprise any type of electronic data processor. The memory may comprise any type of system memory such as static random access memory (SRAM), dynamic random access memory (DRAM), synchronous DRAM (SDRAM), read-only memory (ROM), a combination thereof, or the like. In an embodiment, the memory may include ROM for use at boot-up, and DRAM for program and data storage for use while executing programs.

The mass storage device may comprise any type of storage device configured to store data, programs, and other information and to make the data, programs, and other information accessible via the bus. The mass storage device may comprise, for example, one or more of a solid state drive, hard disk drive, a magnetic disk drive, an optical disk drive, or the like.

The video adapter and the I/O interface provide interfaces to couple external input and output devices to the processing unit. As illustrated, examples of input and output devices include the display coupled to the video adapter and the mouse/keyboard/printer coupled to the I/O interface. Other devices may be coupled to the processing unit, and additional or fewer interface cards may be utilized. For example, a serial interface such as Universal Serial Bus (USB) (not shown) may be used to provide an interface for a printer.

The processing unit also includes one or more network interfaces, which may comprise wired links, such as an Ethernet cable or the like, and/or wireless links to access nodes or different networks. The network interface allows the processing unit to communicate with remote units via the networks. For example, the network interface may provide wireless communication via one or more transmitters/transmit antennas and one or more receivers/receive antennas. In an embodiment, the processing unit is coupled to a local-area network or a wide-area network for data processing and communications with remote devices, such as other processing units, the Internet, remote storage facilities, or the like.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. An apparatus comprising:
a substrate layer; and
a waveguide bundle including a plurality of waveguides extending across the substrate layer, the plurality of waveguides running parallel to one another, wherein the plurality of waveguides include waveguides having three or more different widths.

2. The apparatus of claim 1, wherein the plurality of waveguides includes at least a first waveguide, a second waveguide, and a third waveguide, wherein each of the first waveguide, the second waveguide, and the third waveguide have a different width.

3. The apparatus of claim 1, wherein the plurality of waveguides includes waveguides having three or more alternating widths.

4. The apparatus of claim 3, wherein the plurality of waveguides includes a first set of waveguides having a first width, a second set of waveguides having a second width, and a third set of waveguides having a third width.

5. The apparatus of claim 4, wherein each waveguide in the second set of waveguides is positioned directly in-between a corresponding waveguide in the first set of waveguides and a corresponding waveguide in the second set of waveguides.

6. The apparatus of claim 1, wherein the plurality of waveguides includes waveguides having random widths.

7. The apparatus of claim 6, wherein the waveguide bundle includes at least one waveguide having a unique width that is not shared by any other waveguide in the waveguide bundle.

8. The apparatus of claim 6, wherein each waveguide in the waveguide bundle includes a unique width that is not shared by any other waveguide in the waveguide bundle.

9. The apparatus of claim 1, wherein the plurality of waveguides includes:
a first waveguide comprising a first width;
a second waveguide comprising a second width that is different than the first width; and
a third waveguide comprising a third width that is different than both the first width and the second width.

10. The apparatus of claim 9, wherein the second waveguide is positioned directly in-between the first waveguide and the second waveguide.

11. The apparatus of claim 10, wherein a first gap separates the first waveguide from the second waveguide, and wherein a second gap separates the second waveguide from the third waveguide.

12. The apparatus of claim 11, wherein the first gap has the same width as the second gap.

13. The apparatus of claim 11, wherein the first gap has a different width than the second gap.

14. An apparatus comprising:
a substrate layer; and
a continuous waveguide structure extending over the substrate layer, wherein a width of the continuous waveguide structure varies over a length of the continuous waveguide structure.

15. The apparatus of claim 14, wherein the width of the continuous waveguide structure varies progressively over the length of the continuous waveguide structure.

16. The apparatus of claim 15, wherein the width of the continuous waveguide structure varies at a single absolute rate over the entire length of the continuous waveguide structure.

17. The apparatus of claim 15, wherein the width of the continuous waveguide structure varies in accordance with a dynamic rate, and wherein the dynamic rate changes over the length of the continuous waveguide structure.

18. The apparatus of claim 14, wherein the width of the continuous waveguide structure comprises a plurality of consecutive lengths, and wherein at least some links in the plurality of consecutive links have different widths.

19. The apparatus of claim 18, wherein the continuous waveguide structure comprises at least a first link and a second link, the first link of the continuous waveguide structure comprising a first uniform width, and the second link of the continuous waveguide structure comprising a second uniform width that is different than the first uniform width.

20. The apparatus of claim 18, wherein the continuous waveguide structure comprises at least a first link and a second link, and wherein the width the waveguide structure varies at a different rate over the first link than over the second link.
